(19) United States
(12) Patent Application Publication
(10) Pub. No.: US 2002/0122139 A1
(43) Pub. Date: Sep. 5, 2002

(54) Device for noise reduction in video signals

(76) Inventor: Gerhard Wischermann, Weiterstadt (DE)

Correspondence Address: U.S. Philips Corporation, 580 White Plains Road, Tarrytown, NY, 10591, US

(21) Appl. No.: 10/084,840

(22) Filed: Feb. 26, 2002

(30) Foreign Application Priority Data
Mar. 1, 2001 (DE) 10109968.1

(51) Int. Cl. H04N 5/213

(52) U.S. Cl. 348/607; 348/618

(57) ABSTRACT

In a device for noise reduction in video signals the video signals are split into at least a local lower frequency spectral content and a local higher frequency spectral content. The higher frequency spectral content is passed through a time filter. The output signal of the time filter and the correspondingly time-delayed lower frequency spectral content are added to together to form a noise-reduced video signal.

For noise reduction in video signals devices are known with time recursive filters, for example from DE 27 50 173 C2. The higher the feedback factor is here, the better is the noise reduction because then, ultimately, the video content of many images is averaged out. With moving video content, however, integration from image to image is only possible to a limited extent, since otherwise lack of definition of the moving video content occurs. Therefore in the known device the feedback factor is controlled according to a movement in the image. The movement is determined by finding the value of the differences of the video signals of two consecutive images.

In the known procedure ultimately it is assumed that the noise in moving video content causes less of a problem in moving video content than in static video content. This is, however, in particular with large-area objects, not necessarily the case.

It is therefore an object to specify a device for noise reduction in video signals that even when there is movement brings about a reduction in noise without the interfering artifacts finding their way into the video signals.

This object is achieved in accordance with the invention in that the video signals are split into at least a local lower frequency spectral content and a local higher frequency spectral content, that the higher frequency spectral content is passed through a time filter and that the output signal of the time filter and the correspondingly time-delayed lower frequency spectral content are added together to form a noise-reduced video signal.

The device in accordance with the invention has the advantage that, even in moving image areas a noise reduction is achieved without involved procedures for estimating movement and compensating for this having to be used. Further, the device in accordance with the invention is very resistant to film-flicker disturbance, since this only occurs in the low-pass channel. For in the known procedure for noise reduction the lower frequency film-flicker disturbances generate a considerable deflection in the movement detector of the noise reducer, which leads to a response from the movement detector and thus even for nonmoving images prevents or considerably limits a reduction in noise.

The device in accordance with the invention offers the possibility of limiting the effect of the noise reduction to a maximum local extension of the interference that is expected. Since, for example, the grain of a 35 mm negative film is considerably finer that that of a recopied Super 16 mm film, the aperture of the FIR filter (size of the filter window) can be correspondingly reduced when the signal is split. This leads to still less object reproduction in the higher frequency spectral content and reduces the danger of artifacts, such as pulling on whites and ghosting of moving objects.

Also with the device in accordance with the invention movements present in the higher frequency spectral content can preferably be evaluated in that the time filter is a recursive filter, the feedback factor of which can be controlled by a movement detector, to which the higher frequency spectral content can be fed. Other time filters, such as transversal and median filters, can also be used however.

An advantageous embodiment of the invention is comprised in that, to derive the lower frequency spectral content, a local low-pass filter with a size of approximately 5×≡to 11×11 pixels is provided and in that to derive the higher frequency content a subtraction of the lower frequency spectral content from the video signal delayed according to the filter operating time takes place.

This embodiment has the advantage that when playing back color films interfering grain occurs in the higher frequency content and is thus subject to noise reduction. For the local low-pass filter a FIR filter can preferably be used. The invention can, however, also be built with a two-dimensional (horizontal/vertical) median filter.

With the device in accordance with the invention a differential treatment of various coarse noise structures (grain structures) is also possible, for the purpose of which in a further development it is envisaged that in addition a central spectral content of the video signal is derived and that the central spectral content is passed through a further time filter and the output signal of the further time filter is added to the time-delayed lower frequency spectral content and to the output signal of the time filter.

This further development is preferably embodied such that the further time filter is a further recursive filter, the feedback factor of which can be controlled by a further movement detector that can be fed by the central spectral content.

Since when films are shot incorporation of the light available at that time takes places over an image period, the edges of moving objects have a corresponding lack of definition. Since in these image areas practically no high spectral components of the useful signal occur, with another further development of the invention the noise in these image areas can be reduced by the output signal of the time filter and/or the output signal of the additional time filter being controllable with a movement signal such that the amplitude of the output signal is reduced as the movement increases.

Here it is preferably envisaged that the reduction for a specified value uses one of the movement signals representing the movement and for large movement signals drops to a minimum value.

Examples of embodiment of the invention are shown in the drawing using various Figures, each in the form of a block diagram, and in the following description. The illustrations are:

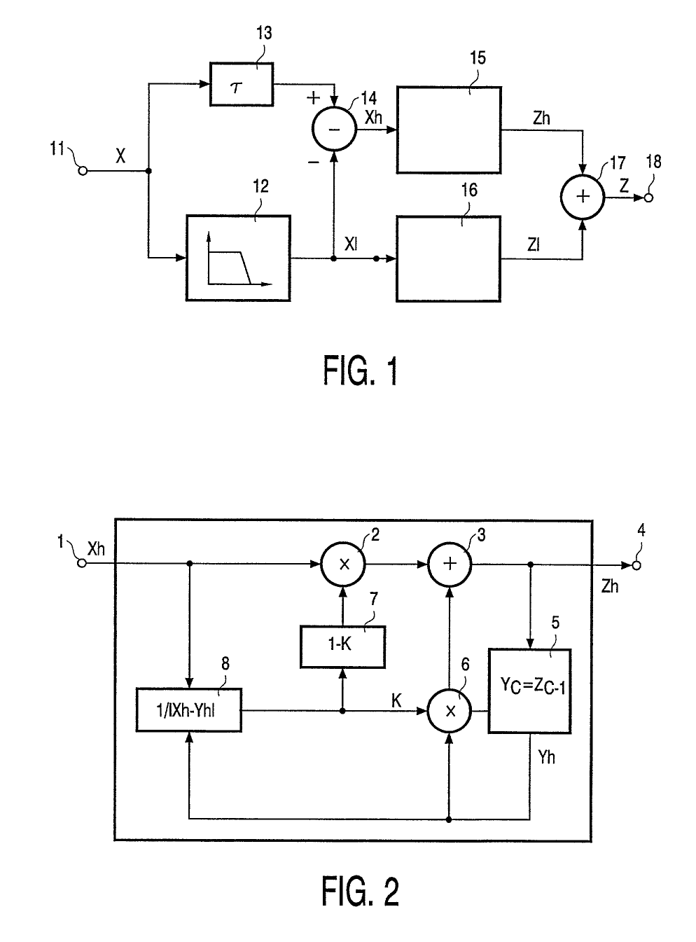

FIG. 1 a first example of embodiment;

FIG. 2 a known noise reducer for use in the device in accordance with the invention;

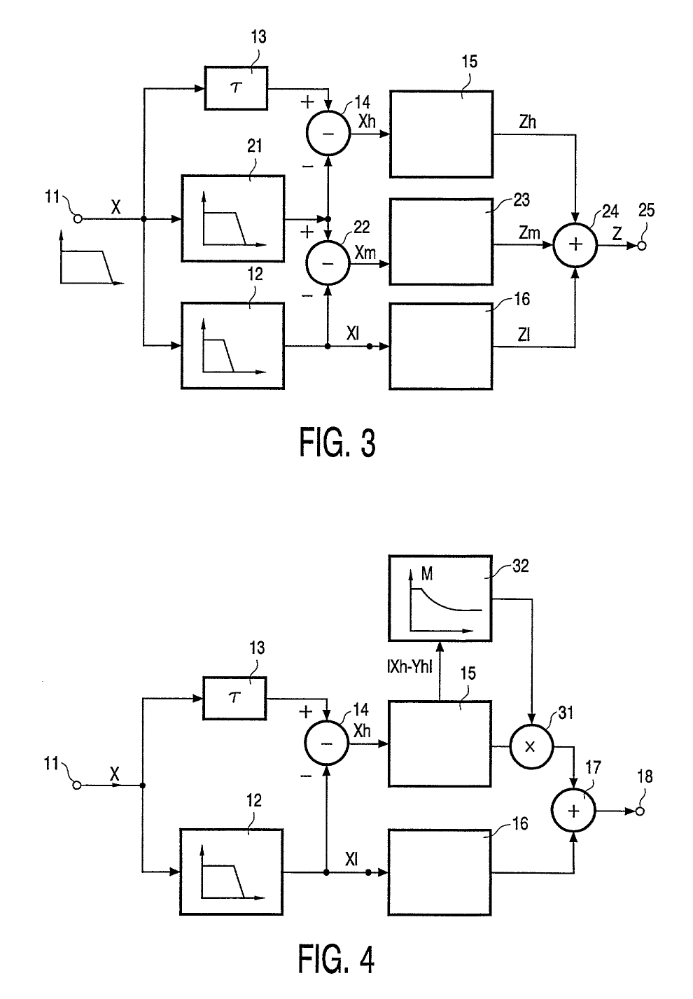

FIG. 3 a second example of embodiment and

FIG. 4 a third example of embodiment.

The representation as a block diagram does not mean that the individual functions are actually carried out in individual circuits. Rather, the use of programmable processors to perform the calculations is possible and advantageous.

Before the definition of the individual examples of embodiment the noise reducer known per se and in accordance with FIG. 2 as it is used in the examples of embodiment is explained.

Via an input 1 the higher frequency spectral content Xh is fed. This reaches the output 4 via a multiplexer 2 and a summer 3 as content Zh. Zh is fed to an image memory and read out of from the image memory as signal Yh time-delayed by one image period. The signal Yh is fed by a second multiplexer 6 to the summer 3. The multiplexer 6 is fed a feedback factor K and the multiplexer 2 via a circuit 7 a factor 1-K.

In this connection the device in accordance with FIG. 2 contains a known recursive filter. If K=0, Xh is passed on unchanged to the output 4. For K=0 there is no noise reduction. With an increasing K, the content of the signal Yh read out from the image memory 5 in the output signal Zh also increases. If K=1 only the saved signal Yh is now read out and re-written. For reasons of stability the maximum value of K is kept at something less than 1. An averaging of consecutive images in the image memory 5 then takes place so that statistical interference (noises) is reduced.

The feedback factor K is derived in the noise reducer in accordance with FIG. 2 in that at 8 the size of the difference in the respective fed-in signal Xh and the signal Yh is found.

In the design example in accordance with FIG. 1 the video signal X from an input 11 is fed to a local low-pass filter as and a time-delay element 13. The low-pass filter 12 is preferably a FIR filter and detects for example five consecutive pixels in five rows. The lower frequency spectral content Xl and the corresponding video signal X delayed at 13 are subtracted at 14, so that the higher frequency spectral content Xh results, which is fed to a noise reducer 15, shown schematically in FIG. 2.

In the branch for the lower frequency spectral contents Xl a time-delay device 16 is arranged. Instead of this time-delay device, however, signal processing circuits can also be inserted which merely work on the lower frequency spectral content, for example a circuit arrangement for reducing lower frequency flicker interference. The spectral contents Zh and Zi are then added at 17 and can be taken from an output 18 as a noise-reduced video signal Z.

The higher frequency spectral contents Xh contain the complete interference content (noises) as well as the fine image details. In the known noise reduction procedure, that works on the complete signal, on the front and rear edges of the moving objects, for example, large differential signals (X-Y) result, so that the feedback factor K is practically zero, which for the purpose of preventing pulling on whites from movements is indeed positive, but in these image areas does not signify reduced noises.

In the device in accordance with the invention—as already explained—only the higher frequency spectral content of the image signal undergoes the noise reduction.

Accordingly only the difference in the higher frequency spectral contents is found as well. Since, however, these only contain the fine image details, the assumed larger object does not occur here. As a result in the signal K considerably lower amplitude excursions occur as well, so that the noise reduction on the edges of moving objects is retained..

In the example of embodiment in accordance with FIG. 3 a further low-pass filter with a higher limiting frequency than the low-pass filter 12 is provided with a further subtraction circuit 22, so that in total spectral contents Xh, Xm and Hl result. For the medium spectral content Xm, a separate noise reducer 23 is provided that has an identical design to that in accordance with FIG. 2. The summer circuit 24 than has three inputs. The signal Z can be taken from the output 25.

With the device in accordance with FIG. 3 by selecting the filter window and as necessary by adjusting the noise reducers 16, 23 the nature of the overall noise reduction can be adapted to individual requirements. Thus, for example, in one of the spectral ranges h or m a stronger noise reduction can be carried out than in the other, in order to create a certain artificial impression—for example the so-called cinema-feeling.

FIG. 4 shows an example of embodiment in which the noise-reducing higher frequency spectral content is fed via a multiplexer 31 to the summer 17. The multiplexer is controlled by a factor M, that attenuates the higher frequency spectral content, if the movement detector of the recursive filter shows a given value that is above the noise threshold. For this purpose the differential signal |Xh-Xy| representing the movement is taken from the noise reducer 15 and fed to a so-called look-up table 32, in which the dependency of the factor M on the movement signal is stored. The factor M, when there is movement, is below the given value 1 and then reduces with a hyperbolic function, for example, to a value of 0.5 when there is strong movement.

1. A device for noise reduction in video signals, characterized in that, the image signals are split into at least a local lower frequency content and a local higher frequency content, that the higher frequency spectral content is passed through a time filter (15) and that the output signal from the time filter (15) and the correspondingly delayed lower frequency spectral content are added to form a noise-reduced video signal.

2. A device as claimed in claim 1, characterized in that, the time filter (15) is a recursive filter, the feedback factor of which can be controlled by a movement detector (8), to which the higher frequency spectral content can be fed.

3. Device as claimed in either of claims 1 or 2, characterized in that, to derive the lower frequency spectral content a local low-pass filter (12) with a size of approximately 5×5 to 11×11 pixels is provided and in that to derive the higher frequency spectral content a subtraction of the lower frequency spectral content from the video signal time-delayed in accordance with the filter operation time takes place.

4. Device as claimed in any of the above claims, characterized in that, furthermore a medium spectral content of the video signal is derived and in that the medium spectral content is passed through a further time filter (23) and in that the output signal from the further time filter (23) is added to the time-delayed lower frequency spectral content and to the output signal of the time filter (15).

5. Device as claimed in claim 4, characterized in that, the further time filter (23) is a further recursive filter, the feedback factor of which can be controlled by a further movement detector, to which the medium spectral content can be fed.

6. Device as claimed in any of the above claims, characterized in that, the output signal from the time filter (15) and/or the output signal from the further time filter (23) can be controlled with a movement signal in such a way that the amplitude of the output signal is reduced as the movement increases.

7. Device as claimed in claim 6, characterized in that, the reduction at a specified value uses a movement signal representing the movement and for a large movement signal drops to a minimum value.
